(19) United States
(12) Patent Application Publication
(10) Pub. No.: US 2007/0083671 A1
(43) Pub. Date: Apr. 12, 2007

(54) SERVLET FILTERS TO DECODE ENCODED REQUEST PARAMETERS

(75) Inventors: Stephen W. Linn, Concord, NC (US); Laura Lee Olson, Rochester, MN (US)

Correspondence Address: MOORE & VAN ALLEN, PLLC For IBM, P.O. Box 13706, Research Triangle Park, NC, 27709, US

(73) Assignee: INTERNATIONAL BUSINESS MACHINES CORPORATION, Armonk, NY (US)

(21) Appl. No.: 11/163,236

(22) Filed: Oct. 11, 2005

(51) Int. Cl. G06F 15/173

(52) U.S. Cl. 709/245; 709/223

(57) ABSTRACT

A method to decode encoded parameters may include finding and removing any parameters in a request Universal Resource Locator (URL) or the like. A servlet filter may be invoked to find and remove delimiters and parameters from the request URL. The method may also include creating a servlet request wrapper and adding any parameters to the servlet request wrapper. The method may further include passing the servlet request wrapper including any parameters to a target servlet to respond to the request URL. The encoding of request parameters allows search engines to follow URL links that they might not follow when the parameters are specified in the standard manner as specified by Hypertext Transfer Protocol.

### BACKGROUND OF THE INVENTION

The present invention relates to navigating the Internet or the like, and more particularly to servlet filters that may be used to decode encoded request parameters.

Search engines, such as Google, Yahoo and the like, can provide very effective mechanisms for users of the Internet or World Wide Web to find information on the Internet by providing navigation to web pages that have characteristics that match the keywords of the user's desired search. Google is a trademark of Google, Inc. in the United States, other countries or both and Yahoo is a trademark of Yahoo, Inc. in the United States, other countries or both. The mapping of web pages to keywords used by these search engines may be generated by programs known as crawlers, spiders or the like. The crawler programmatically searches the Internet, navigating to any and all web links on a particular page, and stores information about each page in a large database. However, many crawlers do not follow links on a page where parameters have been specified or they may limit the number of parameters for links that will be followed. Links with parameters provided as part of a request Universal Resource Locator (URL) may not be accepted by search crawlers. This could prevent these pages from being made available to an end user.

### BRIEF SUMMARY OF THE INVENTION

In accordance with an embodiment of the present invention, a method to decode encoded parameters may include finding and removing any delimiters and parameters in a request URL. The method may also include creating a servlet request wrapper and adding any parameters to the servlet request wrapper. The method may further include passing the servlet request wrapper including any parameters to a target or intended servlet to respond to the request URL.

In accordance with another embodiment of the present invention, a system to decode encoded parameters may include a servlet filter to find and remove any delimiters and parameters in a request URL. The system may also include a servlet request wrapper including any parameters and a target servlet to receive the servlet request wrapper including any parameters.

In accordance with another embodiment of the present invention, a computer program product to decode encoded parameters may include a computer usable medium having computer usable program code embodied therein. The computer usable medium may include computer usable program code configured to find and remove any delimiters and parameters in a request URL. The computer usable medium may also include computer usable program code configured to create a servlet request wrapper and computer usable program code configured to add any parameters to the servlet request wrapper. The computer usable medium may further include computer usable program code configured to pass the servlet request wrapper including any parameters to a target servlet to respond to the request URL.

Other aspects and features of the present invention, as defined solely by the claims, will become apparent to those ordinarily skilled in the art upon review of the following non-limited detailed description of the invention in conjunction with the accompanying figures.

### BRIEF DESCRIPTION OF THE SEVERAL VIEWS OF THE DRAWINGS

FIG. 1 is a flow chart of an example of a method for to decode encoded request parameters in accordance with an embodiment of the present invention.

FIGS. 2A and 2B (collectively FIG. 2) are a block diagram of an example of a system to decode encoded request parameters in accordance with an embodiment of the present invention.

FIG. 3 is an example of a request URL in accordance with an embodiment of the present invention.

### DETAILED DESCRIPTION OF THE INVENTION

The following detailed description of embodiments refers to the accompanying drawings, which illustrate specific embodiments of the invention. Other embodiments having different structures and operations do not depart from the scope of the present invention.

As will be appreciated by one of skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

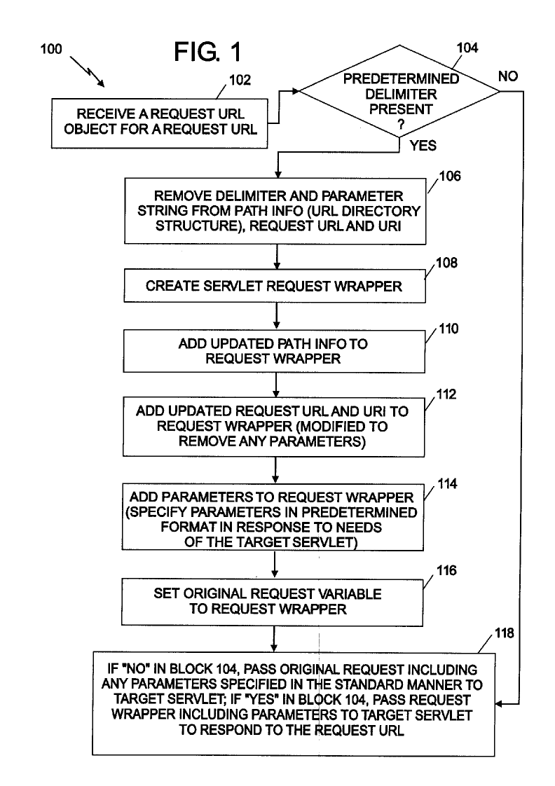

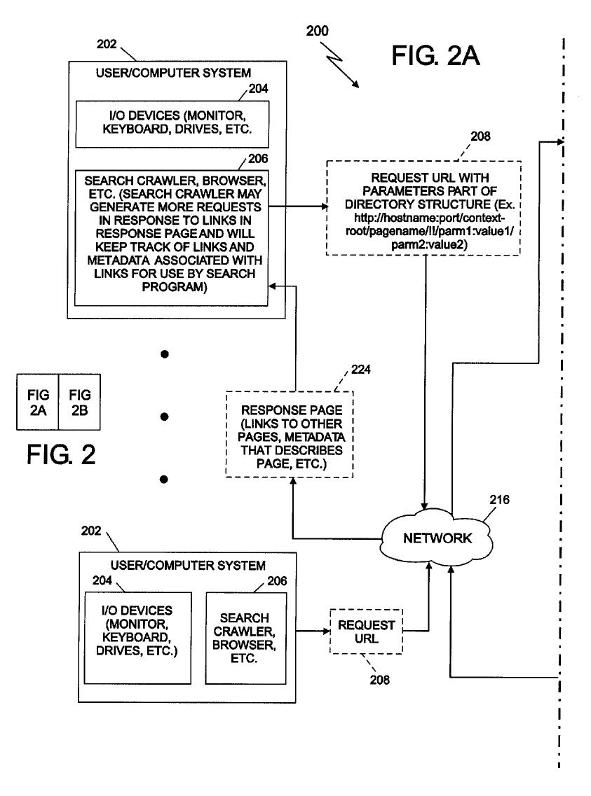

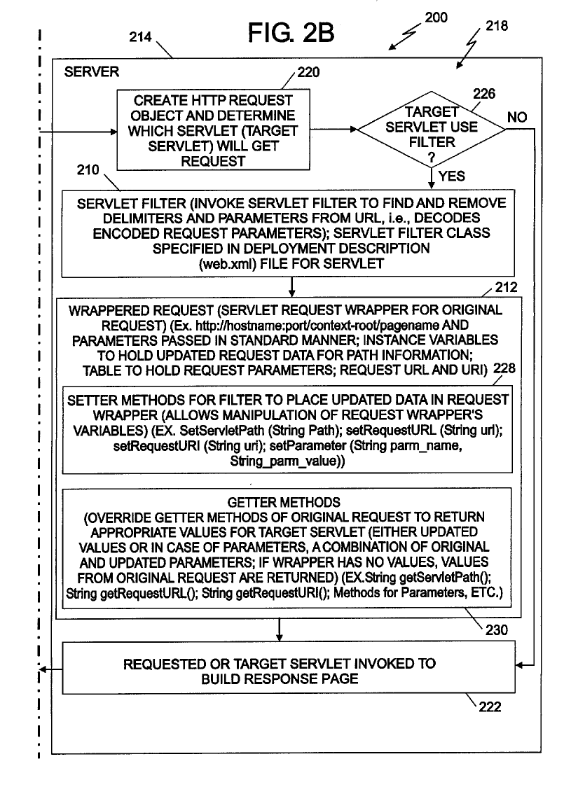

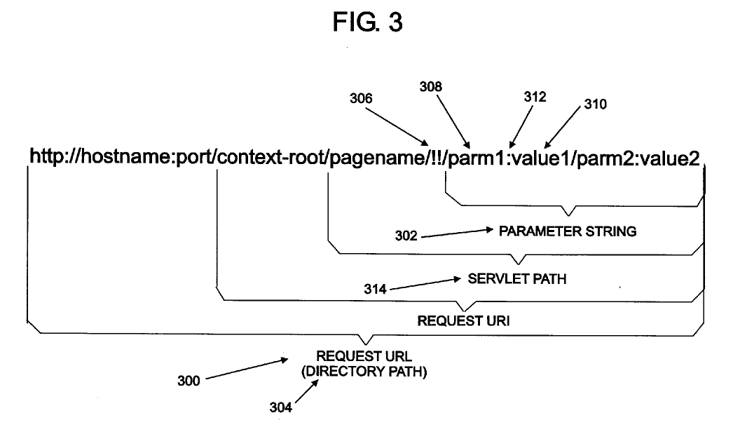

FIG. 1 is a flow chart of an example of a method 100 to decode encoded request parameters in accordance with an embodiment of the present invention. In block 102, a request object for an associated URL may be received. The request URL may be sent by a search crawler, spider, browser or the like. As described in more detail with respect to FIGS. 2 and 3, the request URL may be in a particular format to include parameters as part of a directory structure of the request URL. For example, the beginning of any parameters in a directory structure may be designated by a predetermined delimiter. Additionally, the name of each parameter may be separated from the value associated with that parameter in the directory structure by another predetermined delimiter. The parameters may define information to facilitate the building of a response page for the request URL.

In block 104, a determination may be made whether any predetermined delimiters are present in the request URL. If no predetermined delimiters are present in the request URL, the method 100 may advance to block 118 and the original request including any parameters specified in the standard manner may be passed to a target servlet that has been determined to be able to respond to the request URL. If a predetermined delimiter or delimiters are present in the request URL, the method 100 may advance to block 106. In block 106, the delimiters and parameters may be removed from a directory path information in a URL directory structure of the request URL.

In block 108, a servlet request wrapper may be created. The servlet request wrapper may also have a particular or predetermined format as described in more detail with reference to FIG. 2. In block 110, updated path information will be added to the request wrapper. The updated path information will have the delimiter and parameters provided in the path removed to place the data in an appropriate format for a target servlet.

In block 112, an updated request URL and request uniform resource identifier (URI) will be added to the request wrapper. The updated request URL and URI are modified to remove any parameters. In block 114, parameters parsed out of the directory structure may be added to the request wrapper. The parameters are specified to be in a predetermined format in response to any needs or requirements of the target servlet.

In block 116, the original request variable is set to the request wrapper. This will allow, in block 118, the request wrapper including the parameters to be passed or chained to the target servlet for processing. The target servlet does not recognize the difference of how the parameters were passed to it; however, the search crawler will follow links specifying parameters in this manner. The target servlet will then use the request wrapper and associated parameters to respond to the request URL by creating a response page for sending to the search crawler. The response page may include URL links with parameters as specified in herein that may be accepted by the search crawler for use in accessing other web pages. The response page may include links to other URLs or web pages, metadata that describes the requested page and other information that may be of interest to the end user based on the original request URL and parameters that were part of the original directory structure.

FIGS. 2A and 2B (collectively FIG. 2) are a block diagram of an example of a system 200 to decode encoded request parameters in accordance with an embodiment of the present invention. The method 100 of FIG. 1 may be embodied in and performed by the system 200. The system 200 may include one or more user computer systems 202 or clients. Each user computer system 202 may include input/output (I/O) devices 204. The I/O devices 204 may include input devices, output devices or combination input/output devices. The I/O devices 204 may include a monitor, a keyboard, mouse or pointing device, drives, such as mechanical, magnetic or optical disk drives or the like, or other devices that may facilitate an end user operating and controlling the user computer system 202.

The user computer system 202 or client may also include a search crawler 206, Internet or web browser or similar element to navigate a network, such as the Internet, intranet or other private network. The search crawler 206 may generate a request URL 208 based on keywords or other information entered by a user in a search engine. The request URL 208 may be specified to be placed in a predetermined format by the search crawler 206 to include any parameters as part of a directory structure. Accordingly, the request URL 208 may be specified to have a selected syntax to allow a servlet filter 210 to find and remove any parameters from the request URL and to place them as request parameters in a servlet request wrapper 212 as described in more detail below.

An example of a request URL 300 in accordance with an embodiment of the present invention is illustrated in FIG. 3. The request URL 208 may be the same as URL 300 and may have the same predetermined format or selected syntax. The beginning of any parameters or parameter string 302 in a directory path 304 may be designated by a predetermined delimiter 306. In the example illustrated in FIG. 3, the predetermined delimiter 306 is a pair of exclamation points “!!”. Additionally, a name 308 and a value 310 of each parameter in the directory path 304 or directory structure may be separated by another predetermined delimiter 312. In the example illustrated in FIG. 3, the other predetermined delimiter 312 is a colon “:”.

The request URL 208 (FIG. 2) may be transmitted to a server 214 via a network 216. The network 216 may be the Internet, a private network (intranet, extranet) or other type of network. Different elements or components of the server and a method 218 or functions performed by each of the server elements in accordance with an embodiment of the present invention are illustrated in FIG. 2.

In block 220, the server 214 may create a HyperText Transfer Protocol (HTTP) request object or the like from the request URL 208. The server 214 may also determine which target servlet 222 may be best suited or capable to receive the request URL 208 or object and build a response page 224.

In block 226, a determination may be made whether the target servlet 222 may use a servlet filter 210 as described in a deployment descriptor file for the target servlet 222. A servlet filter class may be described in the deployment descriptor file of the target servlet 218 as illustrated in block 210. The servlet's deployment descriptor file may be an extensible Mark-up Language file (web.xml) or a similar file.

If a determination is made in block 226 that the target filter 218 does not use a servlet filter, the method 218 may advance to the target servlet 222 which may be invoked to build the response page 224. If a determination is made in block 226 that the target servlet 222 may use a servlet filter, the servlet filter 210 may be invoked to find and remove delimiters 306 and parameters (parameter names 310 and values 312 in FIG. 3) from the request URL 208 and 300. Accordingly, the servlet filter 210 may be considered to decode encoded request parameters.

In block 212, a wrappered request or a servlet request wrapper 212 may be formed for the original request URL. The servlet wrapper request 212 may include parameters that may be passed to the target servlet in a standard manner for passing such parameters. The servlet request may also include instance variables to hold updated request data for path information, a table to hold request parameters, a request URL and URI, and possibly other information related to other links or URLs associated with the original request URL 208.

The servlet request wrapper 212 may provide one or more setter methods 228 and getter methods 230. The setter methods 228 may place updated data in the request wrapper 212 and allow manipulation of the request wrapper's variables. Examples of the setter methods are described in more detail below.

The getter methods 230 may override the getter methods of the original request URL 208 and return appropriate values based or any needs or requirements of the target servlet 222. The getter methods 230 may return an updated value for a variable or an original request value for the variable in response to an updated value not being provided for the variable in the request wrapper 212. The getter method or methods may also return a combined list of a plurality of values for variables in response to getting the plurality of values from both the servlet request wrapper 212 and the original request URL 208. The resulting servlet request wrapper may then be passed to the requested or target servlet 222 to build the response page 224 which may be returned to the search crawler 206.

The search crawler 206 may generate more requests in response to links in the response page 208. The search crawler 206 may also keep track of links and metadata associated with the links for use by a search program or engine.

Accordingly, the behavior of the incoming request object 220 (HttpServletRequest) that corresponds to the incoming request URL 208 may be altered by creating the servlet request wrapper 212 (HTTPServletRequestWrapper) for the request URL object and passing the request wrapper to the target servlet 222. The original request object does not provide methods to add, modify, or remove request parameters or to change other data, such as the servletpath, requestURI or requestURL. The wrappered class or servlet request wrapper 212 has access to the original request and its methods and data. A developer can create in the servlet request wrapper 212 additional request data and can provide access methods to access this data using the setter methods 228 and getter methods 230.

In the example illustrated in FIGS. 2 and 3, the request parameters in the request URL 208 and 300 are not in a standard form. The standard form as specified by Hypertext Transfer Protocol (HTTP) is “?Param=value&param2=value2”. The start of parameters is specified by a “?” with the name=value pairs separated by an ampersand “&”. Accordingly, the incoming request URL 300 has no parameters but instead has these parameters on the servlet path 314 as illustrated in the example of FIG. 3. In the servlet request wrapper 212, there are instance variables for the servlet path, requestURL and requestURI, which have these parameters removed. The servlet request wrapper 212 may also have a variable for a list of parameters that may be passed with the request wrapper. A list object is a common java object that is part of the java specification. The actual object is not material in that the wrapper could store the values in any data structure. The code that uses this data must access the data via the getter methods 230 which hide the actual implementation from the using code. The setter methods 228 allow the filter class or servlet filter 210 to take the parameters passed in the servletPath 314 and initialize these values in the request wrapper class 212. In the request wrapper class 212, two types of getter methods 230 may be provided that may override the original request URL's methods. A getServletPath method will return the values set by the servlet filter 210, which will contain the original servlet path minus the passed parameters, and similarly the getter methods for getRequestURL and getRequestURI will return the values set by the servlet filter 210, namely the original request URL and Request URI without the passed parameters. The getparameter* methods are request parameter methods that will consider the data stored in both the original request object 220 and the request wrapper 212. The request wrapper 212 may then be used by the target servlet 222. Thus the request at the target servlet 222 looks like what the request would have looked like if the parameters had been passed in the usual or standard fashion.

Considering the exemplary request URL 300 in FIG. 3, the incoming HttpServletRequest object would have the following data based upon the request getter methods:
getServletPath—/pagename/!!/parm1:value1 /parm2:value2
getRequestURI—context-root/pagename/!!/parm1:value1 /parm2:value2
getRequestURL—http://hostname:port/context-root/pagename/!!/parm1:value1/parm2:value2
getParameter(“parm1”)—null
getParameterNames—empty enumeration
getParameterMap—empty Map
getParameterValues—empty String Array

The parameter getters return null or empty if there are no parameters specified in the standard fashion. The algorithm or method 218 will place the request URL object 220 in an HttpServletRequestWrapper object which will contain modified values of the servletPath, requestURI and requestURL, and a list of the parameters passed as illustrated in FIG. 2. The wrappered request getters or getter methods 230 may then return the following values:
getServletPath—/pagename
getRequestURI—context-root/pagename
getRequestURL—http://hostname:port/context-root/pagename
getParameter(“parm1”)—value1
getParameterNames—enumeration containing both parameters
getParameterMapo13 a map containing both parameters
getParameterValues—a String Array containing both parameter values

Thus, the setter methods 228 in the request wrapper 212 may allow the servlet filter 210 to set the updated values for the original URL request object 220 in the wrappered request 212. The getter methods 230 may override and augment the getter methods in the original request object for the intended servlet or target servlet 222 of the request. Since the request wrapper 212 is passed to the servlet 222, the request wrapper getter methods 230 for all but the above methods will be provided by the original request, but the above methods may provide either the updated data or, in the case of the parameter related methods, may provide a combination of parameter data in the original request URL 208 and request wrapper 212.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A method to decode encoded parameters, comprising:
finding and removing any delimiters and parameters in a request URL;
creating a servlet request wrapper;
adding any parameters to the servlet request wrapper; and
passing the servlet request wrapper including any parameters to a target servlet to respond to the request URL.

2. The method of claim 1, further comprising specifying a particular format for the request URL to include any parameters as part of a directory structure.

3. The method of claim 2, specifying that the request URL have a selected syntax.

4. The method of claim 3, further comprising specifying that the beginning of any parameters in a directory path be designated by a predetermined delimiter.

5. The method of claim 4, further comprising specifying that a name and value of each parameter in the directory path be separated by another predetermined delimiter.

6. The method of claim 1, further comprising creating a request object based on the request URL.

7. The method of claim 1, further comprising invoking a servlet filter to find and remove any delimiters and parameters from the request URL in response to the target servlet being described as using the servlet filter.

8. The method of claim 7, further comprising specifying a servlet filter class in a deployment descriptor file of the target servlet.

9. The method of claim 7, wherein the servlet filter decodes any encoded parameters in the request URL.

10. The method of claim 1, further comprising adding any updated path information to the servlet request wrapper.

11. The method of claim 1, further comprising:
modifying the request URL and a request URI in the servlet request wrapper to remove any parameters; and
specifying that any parameters be in a predetermined format in response to any needs of the target servlet.

12. The method of claim 1, wherein the servlet request wrapper comprises:
a plurality of instance variables to hold updated request data for the path information;
a table to hold any request parameters;
a request URI and the request URL;
at least one setter method for each instance variable; and
at least one getter method for each instance variable.

13. The method of claim 1, further comprising providing at least one setter method for each instance variable to place any updated data in the servlet request wrapper.

14. The method of claim 1, further comprising providing at least one getter method for each instance variable to override at least one getter method of the request URL to return appropriate values of any variables for the target servlet.

15. The method of claim 1, further comprising providing at least one getter method for each instance variable to return one of an updated value for a variable and an original request value for the variable in response to an updated value not being provided for the variable.

16. The method of claim 15, further comprising returning a combined list of a plurality of values for variables from the at least one getter method for each instance variable in response to getting the plurality of values from both the servlet request wrapper and the original request URL.

17. A system to decode encoded parameters, comprising:
a servlet filter to find and remove any delimiters and parameters in a request URL;
a servlet request wrapper including any parameters; and
a target servlet to receive the servlet request wrapper including any parameters.

18. The system of claim 17, wherein the request URL comprises a particular format to include any parameters as part of a directory structure.

19. The system of claim 17, further comprising a setter method to manipulate any variables of the servlet request wrapper and to update data in the servlet request wrapper.

20. The system of claim 17, further comprising a getter method to override a getter method of the request URL to return appropriate values of any variables for the target servlet.

21. A computer program product to decode encoded parameters, the computer program product comprising:
a computer usable medium having computer usable program code embodied therein, the computer usable medium comprising:
computer usable program code configured to find and remove any delimiters and parameters in a request URL;
computer usable program code configured to create a servlet request wrapper;
computer usable program code configured to add any parameters to the servlet request wrapper; and
computer usable program code configured to pass the servlet request wrapper including any parameters to a target servlet to respond to the request URL.

22. The computer program product of claim 21, further comprising computer usable program code configured to create a request object based on the request URL.

23. The computer program product of claim 21, further comprising computer usable program code configured to invoke a servlet filter to find and remove any delimiters and parameters from the request URL in response to the target servlet being described as using the servlet filter.

24. The computer program product of claim 21, further comprising computer usable program code configured to add any updated path information to the servlet request wrapper.

25. The computer program product of claim 21, further comprising:
computer usable program code configured to modify the request URL and a request URI in the servlet request wrapper to remove any parameters; and
computer usable program code configured to specify any parameters in a predetermined format in response to any needs of the target servlet.
